(19) United States
(12) Patent Application Publication
(10) Pub. No.: US 2013/0027345 A1
(43) Pub. Date: Jan. 31, 2013

(54) USER COMPUTER DEVICE WITH A THERMAL ENERGY GENERATING USER INTERFACE AND METHOD OF OPERATING USER INTERFACE AND METHOD OF OPERATING SAME

(71) Applicant: Charles P. Binzel, Bristol, WI (US)

(72) Inventor: Charles P. Binzel, Bristol, WI (US)

(73) Assignee: MOTOROLA MOBILITY, INC., Libertyville, IL (US)

(21) Appl. No.: 13/206,692

(22) Filed: Aug. 10, 2011

Related U.S. Application Data
(60) Provisional application No. 61/513,045, filed on Jul. 29, 2011.

(51) Int. Cl. G06F 3/044

(52) U.S. Cl. 345/174

(57) ABSTRACT

A user computer device is provided that comprises a touchscreen having a capacitive user interface and a thermal energy generating user interface. The user computer device activates the thermal energy generating user interface based on input received via the capacitive user interface. That is, the user computer receives input from a user via the capacitive user interface, determines a position of the user input based on the input received via the capacitive user interface, and activates an area of the thermal energy generating user interface that based on the determined position of the user input.

### FIELD OF THE INVENTION

The present invention relates generally to user computer devices and, in particular, to a user computer device with a touchscreen having thermal energy output capabilities.

### BACKGROUND OF THE INVENTION

Mobile devices such as cellular telephones, smart phones and other handheld or portable electronic devices such as personal digital assistants (PDAs), headsets, MP3 players, etc. have become popular and ubiquitous. Such mobile devices now often include numerous different types of input/output devices and/or sensors that allow for the mobile device to sense/receive/output signals indicative of a variety of user commands and/or operational conditions. For example, many mobile devices now include not merely buttons that can be pressed by a user, but also input devices such as touch sensitive screens or navigation devices. Also, many mobile devices now include other sensors such as sensors that can detect incoming light signals such as infrared signals, as well as sensors that sense position or movement of the mobile device including, for example, accelerometers.

The operational conditions or context of a mobile device can be of interest for a variety of reasons. Yet, despite the number of different types of input and output devices/sensors that are already implemented in conventional mobile devices, there still remain a variety of operational contexts that can be communicated to a user in only a limited way by use of such existing input and output devices/sensors. Indeed, the use of conventional devices/sensors can provide, at best, very limited feedback to a user in certain types of operational conditions.

Therefore, for the above reasons, it would be advantageous if mobile device(s) could be developed that had improved capabilities in terms of feeding back, to a user, one or more mobile device operational conditions.

### BRIEF DESCRIPTION OF THE DRAWINGS

FIG. 1 is a block diagram of a user computer device in accordance with an embodiment of the present invention.

FIG. 2 is a cross-sectional view of the user computer device of FIG. 1 in accordance with an embodiment of the present invention.

FIG. 3 is a block diagram of an exemplary user computer device in accordance with an embodiment of the present invention.

FIG. 4 is an exemplary layout of a capacitive user interface and an overlapping thermal energy generating user interface associated with a touchcreen of the user computer device of FIG. 1 in accordance with an embodiment of the present invention.

FIG. 5 is an exemplary illustration of a user movement across the touchcreen of FIG. 4 in accordance with an embodiment of the present invention.

FIG. 6 is an exemplary illustration of a user movement across the touchcreen of FIG. 4 in accordance with another embodiment of the present invention.

FIG. 7 is a logic flow diagram illustrating an activation of a thermal energy generating user interface of the user computer device user computer device of FIG. 1 in accordance with an embodiment of the present invention.

FIG. 8 is a logic flow diagram illustrating an activation of the thermal energy generating user interface of the user computer device user computer device of FIG. 1 based on a dynamic tracking of user movement in accordance with another embodiment of the present invention.

One of ordinary skill in the art will appreciate that elements in the figures are illustrated for simplicity and clarity and have not necessarily been drawn to scale. For example, the dimensions of some of the elements in the figures may be exaggerated relative to other elements to help improve understanding of various embodiments of the present invention. Also, common and well-understood elements that are useful or necessary in a commercially feasible embodiment are often not depicted in order to facilitate a less obstructed view of these various embodiments of the present invention.

### DETAILED DESCRIPTION OF THE INVENTION

To address the need for a method and apparatus for that had improved capabilities in terms of feeding back, to a user, one or more mobile device operational conditions, a user computer device is provided that comprises a touchscreen having a capacitive user interface and a thermal energy generating user interface. The user computer device activates the thermal energy generating user interface based on input received via the capacitive user interface. That is, the user computer receives input from a user via the capacitive user interface, determines a position of the user input based on the input received via the capacitive user interface, and activates an area of the thermal energy generating user interface that based on the determined position of the user input.

Generally, an embodiment of the present invention encompasses a method for activating a thermal energy generating user interface of a user computer device. The method includes receiving a user input via a capacitive user interface, determining a position of the user input based on the input received via the capacitive user interface, and activating an area of the thermal energy generating user interface based on the determined position of the user input.

Another embodiment of the present invention encompasses a user computer device comprising a touchscreen comprising a capacitive user interface and a thermal energy generating user interface and a processor coupled to the touchscreen. The processor is configured to receive a user input via the capacitive user interface, determine a position of the user input based on the input received via the capacitive user interface, and activate an area of the thermal energy generating user interface based on the determined position of the user input.

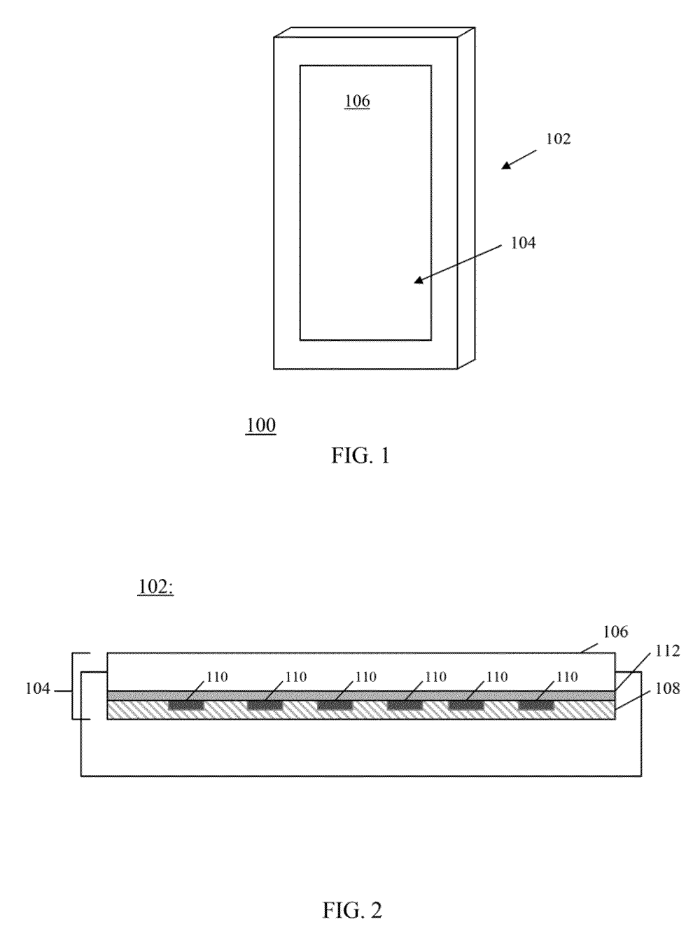

Turning now to the drawings, the present invention may be more fully described with reference to FIGS. 1-8. FIG. 1 is a block diagram of an exemplary user computer device 102 in accordance with an embodiment of the present invention. User computer device 102 may be any user computer device that allows a user to input instructions to the device via a touchscreen 104 and, optionally, may be capable of sending and receiving communication signals on a wireless network. Preferably, user computer device 102 is a wireless mobile device, such as a cellular telephone, a radio telephone, a smart phone, a personal digital assistant (PDA), a laptop computer or a tablet computer with radio frequency (RF) capabilities, or any other handheld or portable electronic device with a user interface comprising a touchscreen that allows a user to input data into, and receive information from, the user computer device; however, user computer device 102 may be any type of user computer device, such as a personal computer or a laptop or tablet computer without wireless capabilities, that has a user interface that includes a ‘capacitive’ and ‘thermally sensitive’ touchscreen.

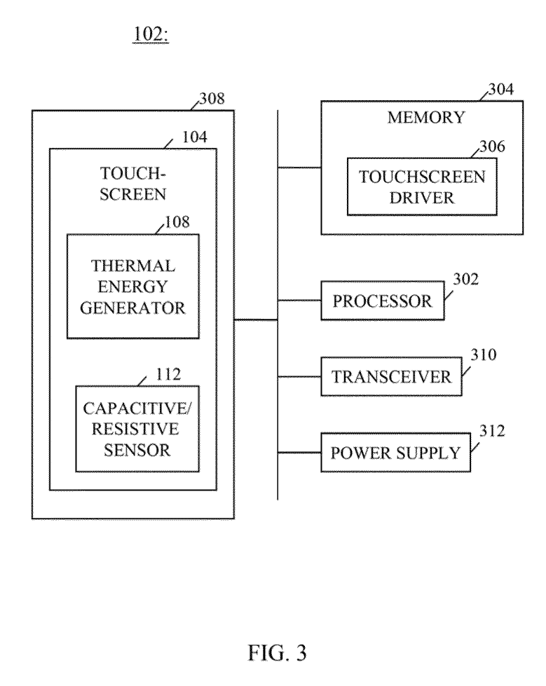

Referring now to FIGS. 1 and 2, touchscreen 104 is a ‘capacitive’ and ‘thermally sensitive’ touchscreen that includes a touchscreen panel 106, typically an insulator such as glass, a capacitive user interface 112, and a thermal energy generating user interface 108. Capacitive user interface 112 includes electrical circuitry that allows for a detection of capacitive changes resulting from a user's touch in different locations on touchscreen 104. Thermal energy generating user interface 108 includes thermal output componentry that allows for output of a user-detectable thermal energy at different locations on touchscreen 104.

The thermal output componentry of user computer device 102 includes multiple thermal energy output devices 110 positioned proximate to, or embedded in, panel 106 of touchscreen 104. As will be described in greater detail below, thermal energy is output by thermal energy output devices 110 that is indicative of elevated temperatures at those respective thermal energy output devices. By virtue of the output of such thermal energy, a user of the user computer device is able to sense a temperature differential existing between an area of touchscreen 104 where such thermal energy output devices 110 are activated and other areas of the touchscreen that do not include activated thermal energy output devices. By detecting areas where thermal energy is output, a user of user computer device 102 may determine an operational condition or context of the user computer device.

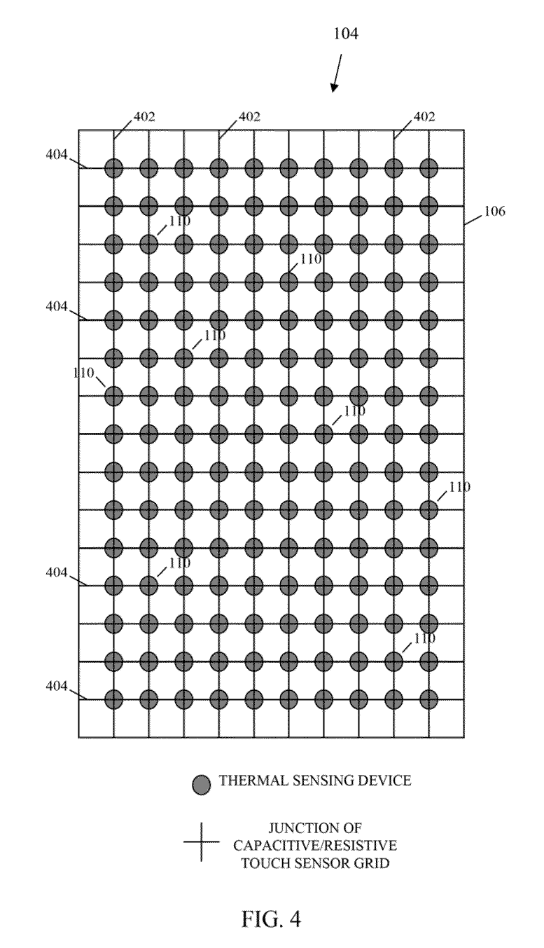

Referring now to FIGS. 3-5, block diagrams are provided of user computer device 102 in accordance with various embodiments of the present invention. Referring first to

FIG. 3, user computer device 102 includes a processor 302 such as one or more microprocessors, microcontrollers, digital signal processors (DSPs), combinations thereof or such other devices known to those having ordinary skill in the art. The particular operations/functions of processor 302, and respectively thus of user computer device 102, are determined by an execution of software instructions and routines that are stored in a respective at least one memory device 304 associated with the processor, such as random access memory (RAM), dynamic random access memory (DRAM), and/or read only memory (ROM) or equivalents thereof, that store data and programs that may be executed by the corresponding processor. However, one of ordinary skill in the art realizes that the operations/functions of processor 302 alternatively may be implemented in hardware, for example, integrated circuits (ICs), application specific integrated circuits (ASICs), a programmable logic device such as a PLD, PLA, FPGA or PAL, and the like, implemented in the user computer device. Based on the present disclosure, one skilled in the art will be readily capable of producing and implementing such software and/or hardware without undo experimentation. Unless otherwise indicated, the functions described herein as being performed by user computer device 102 are performed by processor 302.

User computer device 102 further includes a user interface 308 and, optionally, a transceiver 310 that are each coupled to processor 302. Transceiver 310 includes a wireless receiver (not shown) and a wireless transmitter (not shown) for receiving wireless signals from, and transmitting wireless signals to, another wireless communication device via a corresponding wireless link. User interface 308 includes a display screen that comprises the ‘capacitive’ and ‘thermally sensitive’ touchscreen 104, and further may include a keypad, buttons, a touch pad, a joystick, an additional display, or any other device useful for providing an interface between a user and an electronic device such as user computer device 102. The display screen may comprise a liquid crystal display (LCD), a light emitting diode (LED) display, a plasma display, or any other means for visually displaying information.

User computer device 102 further includes a touchscreen driver 306 that is maintained in at least one memory device 304 and that is executed by processor 302, and thermal energy generating user interface 108 and capacitive sensitive user interface 112 associated with the touchscreen 104 and in communication with the processor. To the extent FIG. 3 is intended to show the internal components of user computer device 102, thermal energy generating user interface 108 may include any arbitrary number of thermal energy output devices 110, and the thermal energy output devices can include a variety of different types of thermal energy output devices. User computer device 102 also includes a limited life power supply 312, such as a removable and/or rechargeable battery, for providing power to the other internal components 302, 304, 306, 308, and 310 of user computer device 102 while enabling the user computer device to be portable.

Touchscreen driver 306 comprises data and programs that control an operation of touchscreen 104, such as sensing a capacitive change in the capacitive user interface of the touchscreen and/or generating a temperature change in the thermal energy generating user interface of the touchscreen, and determining a location of a touch on the touchscreen based on the detected capacitive change, and that may reconfigure an operation of the touchscreen as described in greater detail below. Touchscreen 104 is a ‘capacitive’ touchscreen, as is known in the art. For example, panel 106 of touchscreen 104 may comprise an insulator, such as glass, that may be coated, on an inner surface, with a capacitive user interface comprising a transparent electrical conductor, such as indium tin oxide (ITO). In other examples of a capacitive touchscreen, the capacitive user interface of touchscreen 104 may comprise a grid-type pattern of metallic electrodes that may be embedded in panel 106 or etched in a conductor coupled to an inner surface of the panel. The electrical conductor is, in turn, coupled processor 302 and is controlled by touchscreen driver 306. Touching the outer, uncoated surface of panel 106 with an electrical conductor, such as a human body or a capacitive stylus, results in a change in an electrostatic field and a corresponding change in capacitance that is detected by touchscreen driver 306.

For example, in one type of capacitive touchscreen, a voltage may be applied to the capacitive user interface, that is, the touchscreen's inner surface conductor(s). When a conductor conductive body, such as a human body or a capacitive stylus, touches the outer surface of the touchscreen, a capacitance is created or altered. Processor 302, executing touchscreen driver 306, detects the creation or alteration of a capacitance of the capacitive user interface and is able to determine, based on the detected capacitance, a location of the touch on the touchscreen. For example, the location of the touch may be determined from a variation in the changes in capacitance as measured from the corners of the touchscreen panel. By way of another example, when the touchscreen includes a grid-type pattern (rows and columns) of metallic electrodes, a voltage is applied to the rows and/or columns of the grid. Processor 302 then may determine a location of the touch based on capacitance changes at each individual point (an intersection of a row and a column) in the grid.

Touchscreen 104 further is a thermally sensitive touchscreen, for example, as described in U.S. patent application Ser. No. 12/774,509, attorney docket no. CS37431, entitled “Mobile Device with Thermal output Capability and Method of Operating Same,” and filed on May 5, 2010, and which description of a thermally sensitive mobile device touchscreen is hereby incorporated herein. The thermally sensitive touchscreen comprises a thermal energy generating user interface 108 that is proximate to an inner surface of touchscreen panel 106 or that is embedded in the panel. For example, there may be embedded in, or there may be attached to on an inner surface of, the touchscreen insulator (for example, glass), multiple thermal energy output devices 110. The thermal energy output devices 110 may be any type of device that generates thermal energy when an electrical current is applied to the device and/or a voltage differential is applied across the device. For example, each thermal energy output device 110 may be a resistor or a capacitor that generates thermal energy in response to application of a current or a voltage differential, or may be a thermocouple, such as a thermocouple formed by a respective junction of first and second types of materials such as a Indium Tin Oxide (InSnO₄) ceramic material (ITO) and a Indium Tin Oxide Manganese ceramic material (ITO:Mn). The thermal energy output devices 110 may be distributed throughout the touchscreen (in a different plane, that is, above or below the capacitive user interface associate with the touchscreen, or intermixed with the capacitive user interface). Certain thermal energy output devices may be linked to each other by a graphite strip or other thermally-conductive strip so as to maintain the thermal energy output devices at a same or substantially a same temperature, which temperature may be set at a temperature level different from that of an item that will touch the touchscreen, such as an exposed finger, a gloved finger, or a stylus. The thermal energy output devices also may be electrically connected in series to simplify activation of the devices and/or enhance uniformity of thermal output. Processor 302 is able to selectively activate the thermal energy output devices 110 in order to generate thermal energy at selected locations on touchscreen 104.

Referring now to FIG. 4, an exemplary layout is depicted of capacitive user interface 112 and an overlapping thermal energy generating user interface 108 associated with touchcreen 104 in accordance with an embodiment of the present invention. As depicted in FIG. 4, capacitive user interface 112 includes a grid-type pattern of vertical and horizontal metallic electrodes 402, 404 (a ‘touch sensor grid’) that may be embedded in panel 106 or etched in a conductor coupled to an inner surface of the panel as described in greater detail above. The electrical conductor is, in turn, coupled to processor 302 and is controlled by touchscreen driver 306. Thermal energy generating user interface 108 includes a grid of multiple thermal energy output devices 110 that are proximate to the inner surface of, or embedded in, panel 106 and that are distributed across the touchscreen panel, coupled to processor 302, and controlled by touchscreen driver 306.

Touching the outer, uncoated surface of the panel of the touchscreen with an electrical conductor, such as a human body or a capacitive stylus, results in a change in an electrostatic field and a corresponding change in capacitance that is detected by touchscreen driver 306. Processor 302 then may determine a location of the touch based on capacitance changes at each individual point, that is, at an intersection of a column electrode 402 and a row electrode 404, in the grid and, in response to detecting the location of the touch, generate thermal energy at a given location on touchscreen 104 by activating various thermal energy output devices 110 in thermal energy generating user interface 108.

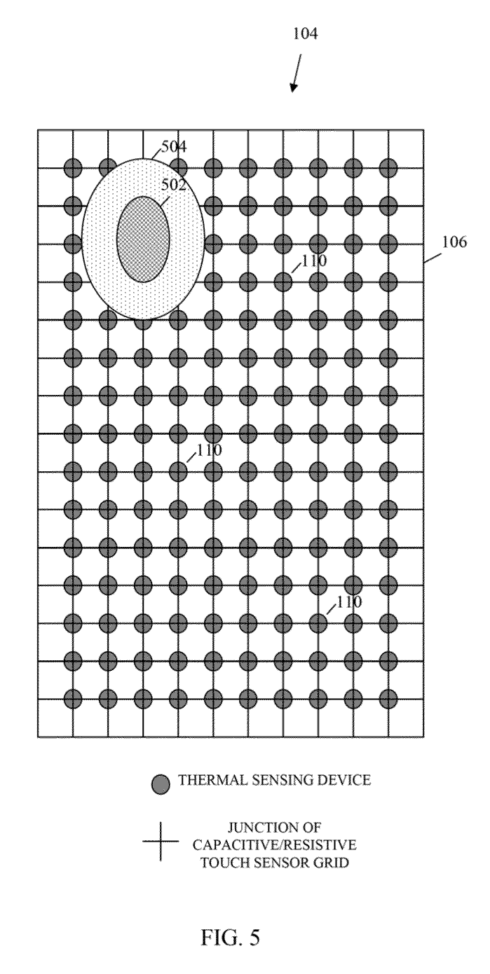

The configuration of FIG. 4 additionally illustrates how, in some embodiments of the present invention, various advantages can be achieved by utilizing multiple thermal energy output devices provided within a given region of touchscreen 104 rather than utilizing only a single thermal energy output device to sense a temperature at a given region of the touchscreen. In particular, FIG. 5 shows that multiple thermal energy output devices can be collectively employed, effectively as a single ‘thermal generator,’ so as to output an elevated temperature within a given region of touchscreen 104. Insofar as these thermal energy output devices operate as a group generator, temperature levels may be elevated to higher levels. This is in contrast to other embodiments where only a single thermal energy output device is present within a given region. Additionally, FIG. 4 illustrates how in some operational conditions it is possible for a variety of different temperature levels within a variety of different regions of the mobile device can be generated by series-connecting any arbitrary number of thermal energy output devices.

Numerous other embodiments with numerous other types of thermal energy output devices and configurations thereof are additionally intended to be encompassed by the present invention. For example, sets of multiple thermal energy output devices positioned proximate to different edges of the touchscreen can all be connected in series with one another. Also for example, where a set of thermal energy output devices are intended to operate as a ‘group generator’ associated with a particular region of the touchscreen, the proximity of those thermal energy output devices with respect to one another can vary depending upon the embodiment. Further, in some embodiments, locally generated thermal energy can be utilized as a thermal virtual icon or softkey. In one embodiment of this type, a first set of thermal energy output devices, for example, 20 thermal energy output devices, can be placed within a first region of touchcsreen 104 and serve as a first ‘button’ while a second set of thermal energy output devices different in number, for example, one device, can be placed in a second region and serve as a second ‘button.’ Assuming all of the thermal energy output devices of the two sets are coupled in series, a user of user computer device 102 then can detect whether the first region or the second region is touched by detecting, through the user's finger, a differential in the thermal energy associated with each region.

As depicted in FIG. 4, various locations in capacitive user interface 112 are associated with corresponding locations in thermal energy generating user interface 108. For example, each thermal energy output device 110 may be associated with one or more points on the capacitive touch sensor grid 402/404, and each point on the capacitive touch sensor grid 402/404 may be associated with one or more thermal energy output devices 110. Thus, a location of, or detected movement along, the capacitive touch sensor grid 402/404 can be associated to a corresponding location of, or detected movement along, the grid of thermal energy output devices 110. Similarly, a location of, or detected movement along, the grid of thermal energy output devices 110 can be associated to a corresponding location of, or detected movement along, the capacitive touch sensor grid 402/404.

For example, when processor 302 detects that a location of a touch is moving from left to right along panel 106 and the capacitive touch sensor grid 402/404, the processor can determine, based on such movement, a corresponding movement from left to right along the grid of thermal energy output devices 110. Further, processor 302 may determine, for any determined location on the capacitive touch sensor grid 402/404, a corresponding location in the grid of thermal energy output devices 110, that is, one or more thermal energy output devices 110 that correspond to any determined location on the capacitive touch sensor grid 402/404.

Thermal energy generating user interface 108 provides thermal feedback to a user of user computer device 102. However, activation of an entirety of thermal energy generating user interface 108 may consume an excessive amount of power and can quickly drain a limited life power supply of a portable user computer device, such as a battery of a cellular phone. Furthermore, concurrent activation of both the entire thermal energy generating user interface and the entire capacitive user interface can be wasteful of device energy. In order to conserve power, user computer device 102 provides for selective activation of portions of thermal energy generating user interface 108 based on detections by capacitive user interface 112.

More particularly, by associating user contact locations and user movements detected by capacitive user interface 112 with corresponding locations in thermal energy generating user interface 108, user computer device 102 is able to provide thermal feedback and anticipatorily activate only portions of the thermal energy generating user interface, thereby minimizing power consumption by the user computer device.

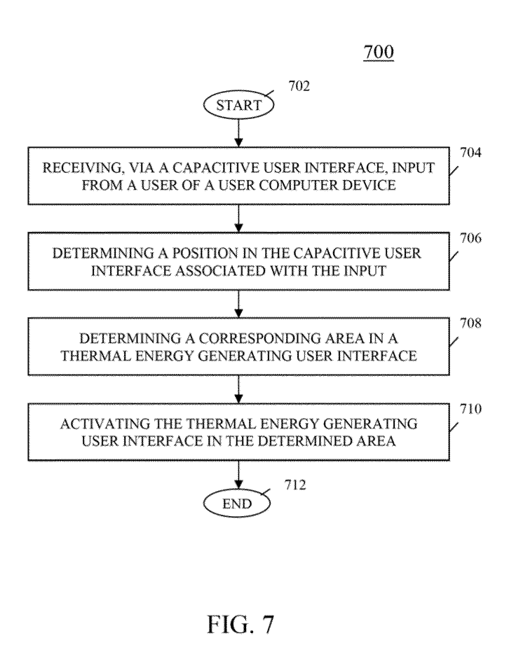

Referring now to FIGS. 5 and 7, a method 700 is depicted of an activation of thermal energy generating user interface 108 of user computer device 102 that minimizes power consumption by the user computer device in accordance with an embodiment of the present invention. Method 700 begins (702) when user computer device 102 receives (704), via capacitive user interface 112 of the user computer device, input from a user of the device. For example, the user may touch touchscreen 104 at a position, or area, 502. In response, capacitive user interface 112 detects the position 502 associated with the user's input, that is, touch, and processor 302 determines (706) a corresponding position 502 in the capacitive user interface. Based on the determined position 502 in the capacitive user interface, processor 302 determines (708) a corresponding position, or area, 504 of touchscreen 104, and correspondingly a portion of thermal energy generating user interface 106 of user computer device 102, that is associated with the user's touch. Processor 302 then selectively activates (710) the portion of thermal energy generating user interface corresponding to the determined position/area 504, that is, activates the thermally sensitive devices 110 associated with, that is, encompassed in, the determined position/area 504, and the logic flow diagram of FIG. 7 then ends (712).

In one example of such an embodiment, the activation of position 504 in the thermal energy generating user interface may comprise providing thermal Braille feedback to a user of user computer device 102. In such an embodiment, the grid of thermally sensitive devices may have sufficient granularity as to be able to provide thermal Braille feedback to a user. In such an embodiment, an area of touchscreen 104 may comprise a virtual keyboard that is divided into groups of virtual keys (softkeys) or buttons. Each key/button has an activation area limited by a border, and by touching touchscreen 104 within the activation area, the user may select a key or button and the capacitive user interface can detect the selection. In response to the capacitive user interface detecting the position of the touch, and processor 302 determining the corresponding key/button selection, the processor activates thermally sensitive devices in that same area that correspond to a Braille character associated with the key/button. Thus the user receives thermal feedback identifying a Braille character associated with the key/button touched. For example, suppose areas 502 and 504 are approximately co-extensive, each being associated with a same virtual key or button of touchscreen 104. When the user touches area 502, this corresponds to the virtual key for the character ‘d.’ Processor 302 detects this touch via the capacitive user interface and, in response, activates thermally sensitive devices 110 in position 504 such that the Braille character ‘d’ is thermally fed back to the user.

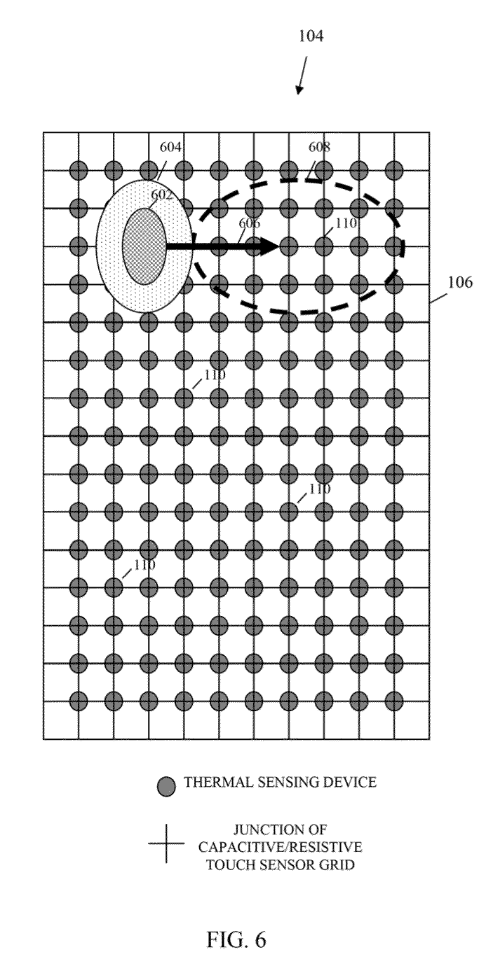

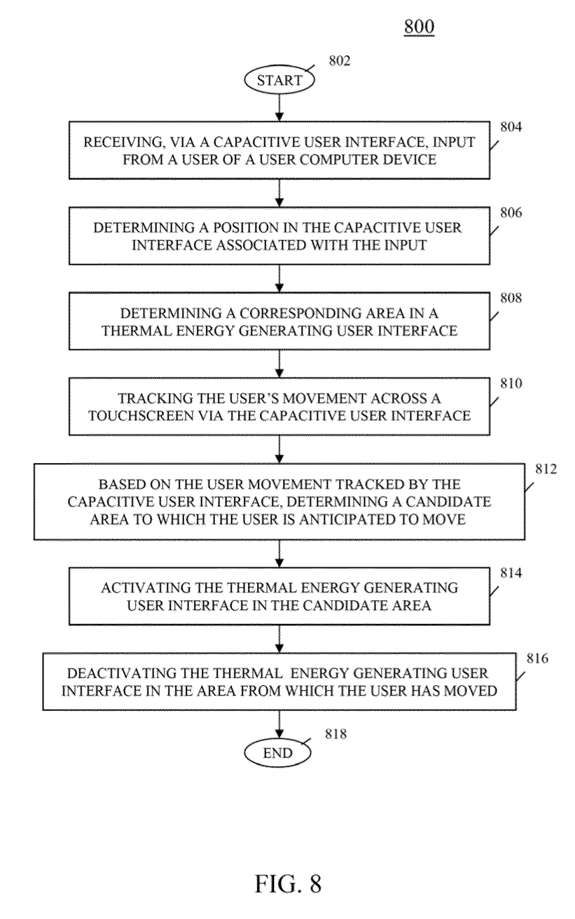

Turning now to FIGS. 6 and 8, a method 800 is depicted of an activation of thermal energy generating user interface 108 of user computer device 102 based on a dynamic tracking of user movement in accordance with another embodiment of the present invention. Method 800 begins (802) when user computer device 102 receives (804), via capacitive user interface 112 of the user computer device, input from a user of the device. For example, the user may touch touchscreen 104 at a position, or area, 602. In response, capacitive user interface 112 detects the position, or area, 602 of this touch and processor 302 determines (806) a corresponding position/area 602 in the capacitive user interface of the user computer device. Based on the determined position 602 in the capacitive user interface, processor 302 determines (808) a corresponding position, or area, 604 in thermal energy generating user interface 108 of user computer device 102.

As the user then slides his or her finger across touchscreen 104, as indicated by arrow 606 in FIG. 6, processor 302 tracks (810) the user's movement across the touchscreen via capacitive user interface 112. Based on the user movement tracked via the capacitive user interface, processor 302 determines (812) a candidate area 608 of touchscreen 104, and correspondingly of thermal energy generating user interface 108 of user computer device 102, to which the processor anticipates the user to move based on the angle and direction of the detected user movement. Processor 302 then selectively activates (814) a portion thermal energy generating user interface 108 associated with the candidate area 608, that is, activates thermal energy output devices 110 associated with, that is, encompassed by, the candidate area. Further, as the user's finger is detected to move into candidate area 608, processor 302 may deactivate (816) a portion of thermal energy generating user interface 108 from which the user's finger has moved, that is, the portion of thermal energy generating user interface 108 associated with area 606. Method 800 then ends (818).

In various embodiments of the present invention, candidate area 608 may comprise a portion of thermal energy generating user interface 108 just ahead of the user's finger or, when the user comes to the end of a horizontal line across the touchscreen, may comprise a portion of the thermal energy generating user interface just below the current position of the finger (for example, assuming that the user will move horizontally across touchscreen 104 and, at the end of a horizontal line, move down and then back in the other direction).

For example, suppose an area of touchscreen 104 comprises a virtual qwerty keyboard that is divided into groups of virtual keys (softkeys). When the user's finger currently rests upon an area corresponding to the characters ‘d.’ (for example, in Braille) and processor 302 detects, via capacitive user interface 112, a horizontal movement of the user's finger to the right, the processor may activate, from left to right in the candidate area, thermal energy output devices 110 (in Braille) corresponding to the characters ‘f,’ ‘g,’ ‘h,’ and ‘j.’ When processor 302 then detects, via the capacitive user interface, a continued horizontal movement of the user's finger to the right and that the user's finger currently rests upon an area corresponding to the character ‘h,’ the processor then may deactivate the thermal energy output devices 110 corresponding to the characters ‘d,’ ‘f,’ and ‘g,’ and activate, from left to right in a new candidate area horizontally to the right of the area associated with the character ‘h,’ thermal energy output devices 110 corresponding to the characters (in Braille) ‘j’ ‘k,’ and ‘1.’

An additional feature of such dynamic tracking of user movement is that processor 302 may compensate for imperfect movement of the user's touch, that is, the user's finger, relative to the orientation of user computer device 102. For example, if the user's movement across touchscreen 104 is not perfectly horizontal, processor 302 may assume that if the detected movement is within a predetermined range of being perfectly horizontal, for example, with +/−20 degrees of being perfectly horizontal, that the user intended the movement to be perfectly horizontal. In response to such a determination, processor 302 may activate characters in a candidate area of the thermal energy generating user interface corresponding to a perfectly horizontal movement.

In yet another embodiment of the present invention, when processor 302 detects via capacitive user interface 112, a movement of the user's touch, for example, the user's finger, across touchscreen 104, the processor may move characters toward the user's touch, that is, finger, in anticipation of the user's touch moving to those characters, for example, moving characters (such a Braille letters) to the left as the user's finger moves to the right. Thus, a virtual qwerty keyboard can be compacted into a smaller space as thermal letters can be activated under a user's finger without requiring the user to move to a completely separate area for each such letter. For example, suppose an area of touchscreen 104 comprises a virtual qwerty keyboard that is divided into groups of virtual keys (softkeys) and the user's finger, while moving to the right, currently rests upon an area corresponding to the letter ‘f.’ When processor 302 detects a continued movement of the finger to the right, the processor may activate, in thermal energy generating user interface 108 and just to the right of the finger but in overlap with the area corresponding to the letter ‘f,’ thermal energy output devices 110 corresponding to the letter ‘g.’ Similarly, when processor 302 detects a continued movement of the finger to the right from the letter ‘g,’ the processor may activate, in the thermal energy generating user interface and just to the right of the finger but in overlap with the area corresponding to the letter ‘g’ thermal energy output devices 110 corresponding to the letter ‘h,’ and so on. Thus, utilization of capacitive user interface 112 to detect a movement of the user's finger across touchscreen 104 and, correspondingly, to activate thermal energy output devices 110 of thermal energy generating user interface 108, can provide for a dynamic redistribution of characters associated with the thermal energy generating user interface based on the detected movement of the user.

By providing for user computer device 102 to activate thermal energy generating user interface 108 based on input received via the capacitive user interface 112, the user computer device is able to selectively activate areas of the thermal energy generating user interface based on anticipated user movement, as opposed to activating both the entire capacitive user interface and the entire thermal energy generating user interface. Concurrent activation of both the entire thermal energy generating user interface and the entire capacitive user interface can be wasteful of device energy. Thus, by selectively activating only portions of thermal energy generating user interface 108, user computer device 102 conserves power and provides for an extended life for a limited life power supply, such as a battery, that may provide operating energy for such a device.

In the foregoing specification, specific embodiments have been described. However, one of ordinary skill in the art appreciates that various modifications and changes can be made without departing from the scope of the invention as set forth in the claims below. Accordingly, the specification and figures are to be regarded in an illustrative rather than a restrictive sense, and all such modifications are intended to be included within the scope of present teachings.

The benefits, advantages, solutions to problems, and any element(s) that may cause any benefit, advantage, or solution to occur or become more pronounced are not to be construed as a critical, required, or essential features or elements of any or all the claims. The invention is defined solely by the appended claims including any amendments made during the pendency of this application and all equivalents of those claims as issued.

Moreover in this document, relational terms such as first and second, top and bottom, and the like may be used solely to distinguish one entity or action from another entity or action without necessarily requiring or implying any actual such relationship or order between such entities or actions. The terms “comprises,” “comprising,” “has”, “having,” “includes”, “including,” “contains”, “containing” or any other variation thereof, are intended to cover a non-exclusive inclusion, such that a process, method, article, or apparatus that comprises, has, includes, contains a list of elements does not include only those elements but may include other elements not expressly listed or inherent to such process, method, article, or apparatus. An element proceeded by “comprises . . . a”, “has . . . a”, “includes . . . a”, “contains . . . a” does not without more constraints, preclude the existence of additional identical elements in the process, method, article, or apparatus that comprises, has, includes, contains the element. The terms “a” and “an” are defined as one or more unless explicitly stated otherwise herein. The terms “substantially,” “essentially,” “approximately,” “about,” or any other version thereof, are defined as being close to as understood by one of ordinary skill in the art, and in one non-limiting embodiment the term is defined to be within 10%, in another embodiment within 5%, in another embodiment within 1% and in another embodiment within 0.5%. The term “coupled” as used herein is defined as connected, although not necessarily directly and not necessarily mechanically. A device or structure that is “configured” in a certain way is configured in at least that way, but may also be configured in ways that are not listed.

The Abstract of the Disclosure is provided to allow the reader to quickly ascertain the nature of the technical disclosure. It is submitted with the understanding that it will not be used to interpret or limit the scope or meaning of the claims. In addition, in the foregoing Detailed Description, it can be seen that various features are grouped together in various embodiments for the purpose of streamlining the disclosure. This method of disclosure is not to be interpreted as reflecting an intention that the claimed embodiments require more features than are expressly recited in each claim. Rather, as the following claims reflect, inventive subject matter lies in less than all features of a single disclosed embodiment. Thus the following claims are hereby incorporated into the Detailed Description, with each claim standing on its own as a separately claimed subject matter.

What is claimed is:

1. A method for activating a thermal energy generating user interface of a user computer device, the method comprising:
receiving a user input via a capacitive user interface;
determining a position of the user input based on the input received via the capacitive user interface; and
activating an area of the thermal energy generating user interface based on the determined position of the user input.

2. The method of claim 1, wherein activating comprises activating one or more thermal energy output devices in the area of the thermal energy generating user interface that corresponds to the determined position of the user input.

3. The method of claim 2, wherein each of the one or more thermal energy output devices comprises a thermocouple.

4. The method of claim 1, wherein the thermal energy generating user interface is proximate to an inner surface of a panel of a touchscreen of the user computer device.

5. The method of claim 4, wherein the capacitive user interface is interposed between the panel of the touchscreen and the thermal energy generating user interface.

6. The method of claim 4, wherein one or more of the capacitive user interface and the thermal energy generating user interface is embedded in the panel of the touchscreen.

7. The method of claim 1, further comprising:
tracking, via the capacitive user interface, the user's movement across a touchscreen;
determining, based on the tracking, a candidate area of the touchscreen to which the user is anticipated to move; and
activating a portion of the thermal energy generating user interface associated with the candidate area.

8. The method of claim 7, further comprising deactivating a portion of the thermal energy generating user interface from which the user has moved.

9. The method of claim 7, wherein activating comprises moving characters toward a user's touch in anticipation of the user's touch moving to those characters.

10. The method of claim 7, wherein activating comprises compensating for imperfect movement of a user's touch relative to an orientation of the user computer device.

11. A user computer device comprising
a touchscreen comprising a capacitive user interface and a thermal energy generating user interface; and
a processor coupled to the touchscreen that is configured to receive a user input via the capacitive user interface, determine a position of the user input based on the input received via the capacitive user interface, and activate an area of the thermal energy generating user interface based on the determined position of the user input.

12. The user computer device of claim 11, wherein the processor is configured to activate an area of the thermal energy generating user interface by activating one or more thermal energy output devices in the area of the thermal energy generating user interface that corresponds to the determined position of the user input.

13. The user computer device of claim 12, wherein each of the one or more thermal energy output devices comprises a thermocouple.

14. The user computer device of claim 11, wherein the thermal energy generating user interface is proximate to an inner surface of a panel of the touchscreen.

15. The user computer device of claim 14, wherein the capacitive user interface is interposed between the panel of the touchscreen and the thermal energy generating user interface.

16. The user computer device of claim 14, wherein one or more of the capacitive user interface and the thermal energy generating user interface is embedded in the panel of the touchscreen.

17. The user computer device of claim 11, wherein the processor further is configured to track, via the capacitive user interface, the user's movement across the touchscreen, determine, based on the tracking, a candidate area of the touchscreen to which the user is anticipated to move, and activate a portion of the thermal energy generating user interface associated with the candidate area.

18. The user computer device of claim 17, wherein the processor further is configured to deactivate a portion of the thermal energy generating user interface associated with an area from which the user has moved.

19. The user computer device of claim 17, wherein the processor is configured to activate a portion of the thermal energy generating user interface by moving characters toward a user's touch in anticipation of the user's touch moving to those characters.

20. The user computer device of claim 17, wherein the processor is configured to activate a portion of the thermal energy generating user interface by compensating for imperfect movement of a user's touch relative to an orientation of the user computer device.
